(19) United States
(12) Patent Application Publication
(10) Pub. No.: US 2025/0124119 A1
(43) Pub. Date: Apr. 17, 2025

(54) DEVICES, METHODS AND SYSTEMS FOR PROVIDING IDENTIFYING INFORMATION OF AN INDIVIDUAL USING QR CODES

(71) Applicant: Amir Arami, Mission Viejo, CA (US)

(72) Inventor: Amir Arami, Mission Viejo, CA (US)

(21) Appl. No.: 18/486,924

(22) Filed: Oct. 13, 2023

(51) Int. Cl. G06F 21/36; G06K 7/10; G06K 7/14; G06K 19/06; G06K 19/077

(52) U.S. Cl. CPC G06F 21/36; G06K 7/10386; G06K 7/1417; G06K 19/06046; G06K 19/0776; G06K 19/07762

(57) ABSTRACT

According to an aspect of the present invention, there is provided a method of providing identifying information of an individual using QR codes, comprising: obtaining identifying information of an individual at a computer terminal; associating the identifying information with a QR code; and attaching the QR code to the person of the individual.

### BACKGROUND

A QR code (short for “quick-response code”) is a type of two-dimensional matrix barcode. A QR code consists of black squares arranged in a square grid on a white background which can be read by an imaging device such as a camera. Encoded data is then deciphered from patterns that are present in both horizontal and vertical components of the image.

Prior art patent literature contains many descriptions of the functionality of QR codes. For example, U.S. Pat. No. 11,663,578 discloses systems and methods for a user to use a trusted device to provide sensitive information to an identity provider via QR (Quick Response) code for the identity provider to broker a website login or to collect information for the website. A user may securely transact with the website from unsecured devices by entering sensitive information into the trusted device. The identity provider may generate the QR code for display by the website on an unsecured device. A user running an application from the identity provider on the trusted device may scan the QR code to transmit the QR code to the identity provider. The identity provider may validate the QR code and may receive credential information to authenticate the user or may collect information for the website. Advantageously, the user may perform a safe login to the website from untrusted devices using the trusted device.

U.S. Pat. No. 10,762,406 describes methods and apparatus for generating a secure QR code for use in a purchase transaction. In an embodiment, a directory service computer verifies the identity of a merchant by matching an acquirer financial institution (FI)-signed certificate and a stored certificate, wherein the acquirer FI-signed certificate was received from a merchant device along with a secure QR code request. The directory service computer then establishes an encrypted and Pinned SSL tunnel with the merchant device, receives a transaction message including a transaction amount, a universal unique identifier (UUID), and a transaction identifier (ID), updates an application transaction count (ATC) associated with the merchant, and generates and stores a secure one-way Hash value, generated by using a merchant identifier (ID), the transaction amount, the ATC, the UUID, and the transaction ID. The directory service computer next generates a dynamic secure QR code by combining the Hash value, the transaction ID and the merchant ID, and transmits the dynamic secure QR code to the merchant device for use in conducting a purchase transaction.

Nevertheless, the functionality of QR codes is only beginning to be explored, and new applications are possible.

### SUMMARY OF INVENTION

Therefore, the present invention provides a QR code with identifying information for attaching to the person of an individual such as a child or an elderly individual with dementia.

According to an aspect of the present invention, there is provided a method of providing identifying information of an individual using QR codes, comprising: obtaining identifying information of an individual at a computer terminal; associating the identifying information with a QR code; and attaching the QR code to the person of the individual.

According to another aspect of the present invention, there is provided a QR code, comprising: a surface with a QR code printed; and a fastener attaching the surface to an article of clothing, wherein the QR code encodes identifying information of an individual.

According to yet another aspect of the present invention, there is provided a system, comprising: a mobile device with a QR code reader; a surface with a QR code printed; and a fastener attaching the surface to an article of clothing, wherein the QR code encodes identifying information of an individual.

### BRIEF DESCRIPTION OF THE DRAWINGS

FIG. 1 illustrates a guardian QR code according to an embodiment of the present invention.

FIG. 2 illustrates utilizing the guardian QR code to obtain information about an individual.

### DETAILED DESCRIPTION

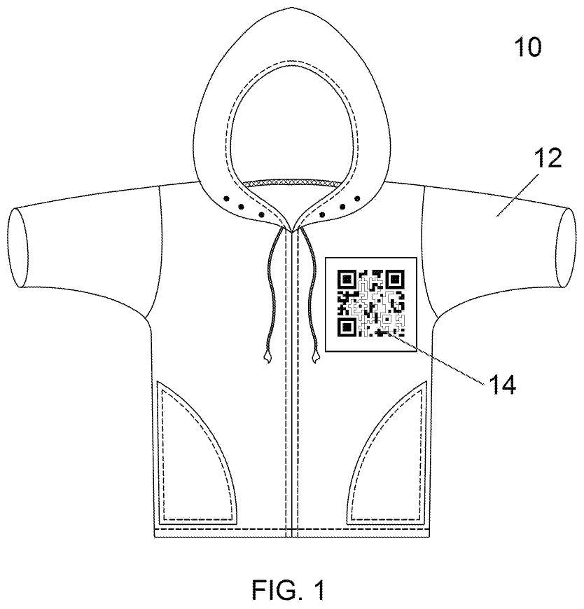

In FIG. 1, person 10 may be, for example, a young child, an elderly person with dementia, or a person with an intellectual or physical disability which makes it difficult for the person to communicate information such as their name and address.

Clothing 12 provides a surface for attaching guardian QR code 14. Clothing 12 could be a shirt, jacket, or any other type of article of clothing, and could be a wide variety of fabrics, such as cotton, linen, polyester, silk and bamboo-derived rayon, though certain fabrics may be more or less suitable for certain manners of fastening guardian QR code 14.

Guardian QR code 14 can be attached to clothing 12 by an iron on patch, button, sewable fabric, fabric sticker, fabric stamp, printed tag on clothing, and a wide variety of other means. Typically guardian QR code 14 would not be applied directly to the skin, but it is possible to do so in some embodiments including by use of e.g., temporary tattoo.

Guardian QR code 14 can be printed on a pin button joining it to clothing 12. Buttons can be made of metal but also may be made of plastic, wood, or seashell in other embodiments. The size of the pins can vary depending on what purchaser prefers.

A number of different types of buttons can be used in embodiments. Flat buttons have holes through which thread is sewn to attach the button. Shank buttons have a hollow protrusion on the back through which thread is sewn to attach the button. Magnetic buttons can be used to join guardian QR code 14 to clothing 12 with magnetic force. Magnetic buttons can be attached to clothing 12 either by sewing or snapping them into the fabric.

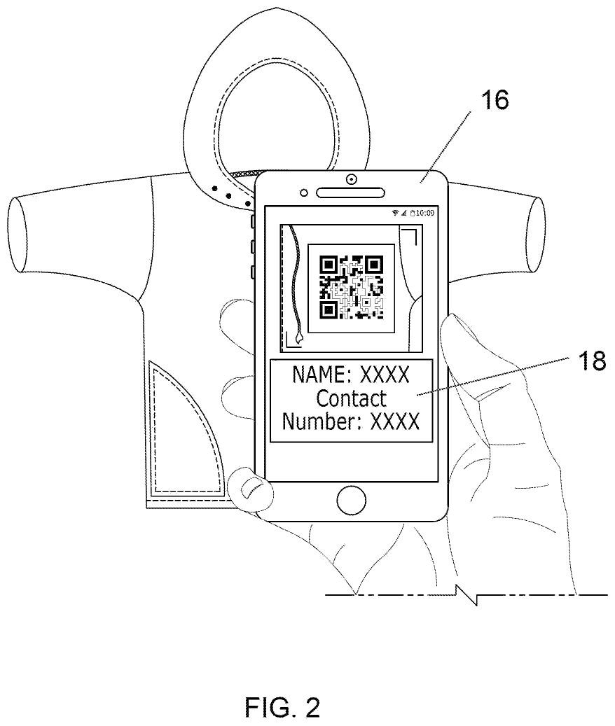

FIG. 2 illustrates utilizing the guardian QR code to obtain information about an individual.

Scanning device 16 is typically a mobile device such as a phone, but could be other types of devices. If a child is lost and found by a stranger, the person can take a picture of the QR code and contact the parents to come get the child. When the QR code is scanned by a stranger, a ping can be sent to the parent immediately notifying them of the location, using the scanner's GPS within the mobile device.

A GPS tag can also be included with the guardian QR code to enhance safety further. The QR code could be stuck to an air tag, for example. An RFID tracker could be used be used as well in conjunction with a QR code.

Individual details 18 are obtained from the QR code. Individual details can be obtained from a customer being sent to a registration website where data is input related to an individual, for example. Parents for example could input their name and contact number.

A list of QR codes with associated information can be displayed on the registration website.

The present invention provides a convenient and affordable way for strangers to help locate people who have gone missing and may not have a device with GPS or know how to use one.

The QR locators can be used for dementia and Alzheimer's patients as well. Each pin button having a QR code can come with a label stating if a patient has Alzheimer's or dementia. QR codes can also have medical information for emergency situations encoded. There is no limit to the amount of information about the individual which can be encoded in the QR code, and the present invention provides improved means compared to such prior art devices as allergy and medical alert bracelets to provide such information when needed.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method of providing identifying information of an individual using QR codes, comprising:
obtaining identifying information of an individual at a computer terminal;
associating the identifying information with a QR code; and
attaching the QR code to the person of the individual.

2. The method of claim 1, wherein the identifying information includes contact information for a guardian of the individual.

3. The method of claim 1, wherein the identifying information includes medical history of the individual.

4. The method of claim 1, further comprising reading the QR by a mobile device reader.

5. A QR code, comprising:
a surface with a QR code printed; and
a fastener attaching the surface to an article of clothing,
wherein the QR code encodes identifying information of an individual.

5. The QR code of claim 5, wherein the fastener comprises a pin attached to a button.

7. The QR code of claim 5, wherein the fastener comprises an adhesive.

8. The QR code of claim 5, wherein the fastener is magnetic.

9. The QR code of claim 5, further comprising a GPS device housed in the fastener.

10. A system, comprising:
a mobile device with a QR code reader;
a surface with a QR code printed; and
a fastener attaching the surface to an article of clothing,
wherein the QR code encodes identifying information of an individual.
